(19) United States
(12) Patent Application Publication
(10) Pub. No.: US 2026/0147482 A1
(43) Pub. Date: May 28, 2026

(54) APPARATUSES AND METHODS FOR ACTIVATION COUNT INITIALIZATION DURING SOFT POST-PACKAGE REPAIR

(71) Applicant: Micron Technology, Inc., Boise, ID (US)

(72) Inventors: Yang Lu, Boise, ID (US); John E. Riley, McKinney, TX (US); Randall J. Rooney, Boise, ID (US)

(73) Assignee: Micron Technology, Inc., Boise, ID (US)

(21) Appl. No.: 19/394,354

(22) Filed: Nov. 19, 2025

Related U.S. Application Data
(60) Provisional application No. 63/725,983, filed on Nov. 27, 2024.

(51) Int. Cl. G06F 3/06

(52) U.S. Cl. CPC G06F 3/0614; G06F 3/0659; G06F 3/0673

(57) ABSTRACT

Embodiments of the disclosure are drawn to apparatuses and methods for initializing an activation count during a soft post-package repair (sPPR). After packaging, it may be necessary to perform post-package repair operations on rows of the memory. During an sPPR operation, an address of an original row of memory may be associated with an open repair address instead, such as when the original row is determined to be damaged or defective. When the repair row is associated with the original row, it may be necessary to initialize an activation count associated with the repair row to prevent unnecessary refresh operations occurring on the repair row and adjacent rows.

### CROSS REFERENCE TO RELATED APPLICATIONS

This application claims the filing benefit of U.S. Provisional Application No. 63/725,983, filed Nov. 27, 2024. This application is incorporated by reference herein in its entirety and for all purposes.

### BACKGROUND

This disclosure relates generally to semiconductor devices, and more specifically to semiconductor memory devices. In particular, the disclosure relates to memory, such as dynamic random-access memory (DRAM). Information may be stored on individual memory cells of the memory as a physical signal, such as a charge on a capacitive element. At various points in manufacturing and use of a memory device, one or more memory cells may fail. For example, memory cells may become unable to store information, be inaccessible by the memory device, etc. When one or more memory cells fail, they may need to be repaired.

The memory device may perform repair operations on a row-by-row basis. A row containing a failed memory cell may be identified. The memory device may contain additional rows of memory which may be used in repair operations. During a repair operation, an address associated with the defective row may be redirected, such that the address points to a repair row instead.

As memory components have decreased in size, the density of memory cells has greatly increased. Repeated activation of a particular memory cell or group of memory cells may cause an increased rate of data degradation in nearby memory cells. Memory devices use various schemes to identify addresses that are repeatedly activated so that the nearby memory cells may be refreshed. One way to identify addresses that are repeatedly activated is to keep a count of the number of activations for a particular row. The count may need to be initialized to a starting value before the device begins to keep track of the number of activations in a given time period. Memory devices may also use various schemes to initialize the count associated with a row such that initialization values do not cause false identification of attacks.

### BRIEF DESCRIPTION OF THE DRAWINGS

FIG. 1 illustrates a block diagram of an example system according to an embodiment of the disclosure.

FIG. 2 illustrates a block diagram of an example memory rank according to an embodiment of the disclosure.

FIG. 3 is a block diagram of a memory device according to at least some embodiment of the disclosure.

FIG. 4 is a flow chart of a repair operation according to some embodiments of the present disclosure.

FIG. 5 is a timing chart showing signals during an example repair operation according to an embodiment of the present disclosure.

FIG. 6 is a timing chart showing signals during an example repair operation according to an embodiment of the present disclosure.

FIG. 7 is a flow chart of a repair undo operation according to some embodiments of the present disclosure.

FIG. 8 is a timing chart showing signals during an example repair undo operation according to an embodiment of the present disclosure.

FIG. 9 is a timing chart showing signals during an example repair undo operation according to an embodiment of the present disclosure.

### DETAILED DESCRIPTION

The following description of certain embodiments is merely exemplary in nature and is in no way intended to limit the scope of the disclosure or its applications or uses. In the following detailed description of embodiments of the present systems and methods, reference is made to the accompanying drawings which form a part hereof, and which are shown by way of illustration specific embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The following detailed description is therefore not to be taken in a limiting sense, and the scope of the disclosure is defined only by the appended claims.

A memory system may include a plurality of memory ranks that each include one or more memory devices. The one or more memory devices may include one or more memory dies. Semiconductor memory devices may store information in a plurality of memory cells. The information may be stored as a binary code and each memory cell may store a single bit of information as either a logical high (e.g., a “1”) or a logical low (e.g., a “0”). The memory cells may be organized at the intersection of word lines, or rows, and bit lines, or columns. The memory may further be organized into one or more memory banks, each of which may include a plurality of rows and columns. During operations, the memory device may receive a command and an address which specifies one or more rows and one or more columns then execute the command on the memory cells at the intersection of the specified rows and columns and/or along an entire row/column.

A memory bank may include original rows that are identified by respective row addresses. The memory banks may also include repair rows of memory to which the address of an original row including defective memory cells may be remapped. In this manner, a defective original row may be “repaired” by accessing a repair row designated for the row address instead of the defective original row. Certain memory cells may be defective or there may be reasons to need redundant storage associated with a certain memory cell. In some cases, the original rows may be incapable of storing information and/or may become otherwise inaccessible to the memory die. The memory cells may become defective, or may be identified as defective, after the memory system is packaged in which case the memory die may carry out one or more types of post-package repair (PPR) operation to resolve the defective rows.

As previously described, memory banks may include a number of additional rows of memory, which may generally be referred to as repair rows or redundant rows. During a repair operation, a row address associated with an original row may be redirected so that it is associated with one of the repair rows instead. In some modes of operation, the repair operation may be a “hard,” or permanent, repair operation, where updated row address information is stored in the memory in a non-volatile form. Repair operations may also be “soft,” where row address information is associated with a repair row in a volatile form.

During a soft PPR (sPPR) operation, volatile elements may be used to track repairs. During an sPPR operation performed on a given row, the address of the open repair row and the address of the row to be repaired, or the original row, may be stored in volatile elements, such as latch circuits, so that information which would have been directed to the row to be repaired, or the original row, is directed to the repair row instead.

Various patterns of activating a row, which may be a repair row or an original row, may cause an increased rate of information decay in memory cells along nearby rows. A row experiencing such patterns of activation may be called an aggressor row and the nearby rows may become victim rows. For example, repeated activation of the aggressor row may increase a rate of decay in adjacent rows and/or in rows which are farther away. This increased rate of decay, above the rate expected by the refresh timing, may risk the loss of information in the victim rows. Accordingly, some memories may track a number of activations of each row, including repair rows, to determine if they are aggressors so that victim rows can be identified and refreshed as part of a targeted refresh operation.

Counting activations of each row may be referred to as a per row activation counter (PRAC) scheme. In some embodiments, to implement such a scheme, each word line of a memory array has an associated activation count value stored in counter memory cells along that word line. The activation count value is used to determine how many times that word line has been activated. When the word line is activated the activation count value may be changed, for instance incremented, by a counter circuit and compared to a mitigation threshold by a comparator. If the activation count value crosses the mitigation threshold, then the address may be added to an aggressor queue and during targeted refresh operations, the addresses in the queue are used to generate refresh addresses.

There may be times when the counter memory cells have an unknown state. For example, after power up, the counter memory cells may be populated with random-like bits. If the memory is immediately used, the random state of the bits may create various issues, such as an illusion of an aggressor. An illusion of an aggressor may occur because some activation count values start at a much higher value due to the random bits assigned at power up. To prevent an illusion of an aggressor, the memory device may initialize the counter memory cells with an initialization value. The initialization value may be such that it is known by the memory device or falls within a known range. There may be other situations which require initialization of the activation counters, for example, if refresh requirements are violated and the counters are placed in an unknown state. Other example situations which may require activation counter initialization may be when a repair row is designated for an original row or when a repair is undone on the original row. To prevent the random state of the activation count values from causing undesired memory operations, the memory may initialize the activation count values before memory operations begin or when the counters are in an unknown state.

The present disclosure is drawn to apparatuses, systems, and methods for initializing activation count values of repair rows during an sPPR operation. A memory rank of a memory system may be placed in a repair mode. The repair mode may be a soft post package repair (sPPR) mode. The memory rank may enter the repair mode responsive to a repair command. The repair command, such as an sPPR command, may be issued by a memory controller. For example, the repair command may be a mode register write (MRW) command that sets a register of a mode register to enable the sPPR mode, or repair mode. During the repair mode, the memory rank may activate a repair row of memory devices included in the memory rank. A repair row may be a repair word line WLR, or redundant word line, of a memory array in the memory devices. The memory rank may receive a repair signal identifying a repair target. The repair signal may include multiple signals. The repair signal may be issued by a controller and may indicate the repair target, such as a specific memory device. The repair target indication may be a particular data signal, such as a low signal on one or more DQ lines for a pre-determined amount of time.

Once the repair target is identified, a repair circuit, or an sPPR circuit, may update a repair address latch associated with the repair row with a row address of an original row. Then the repair target and/or memory rank including the target device may initialize an activation count associated with the repair row. The activation count of the repair row may be initialized with an operation such as an activation count update (ACU) operation or an activation count initialization (ACI) operation during which the activation count is initialized with an initialization value. The initialization value may be written to counter memory cells of the repair row and may be a random number, pseudo-random number, semi-random number, deterministic number, or combinations thereof. The memory rank may then precharge or deactivate the repair row and exit the repair mode.

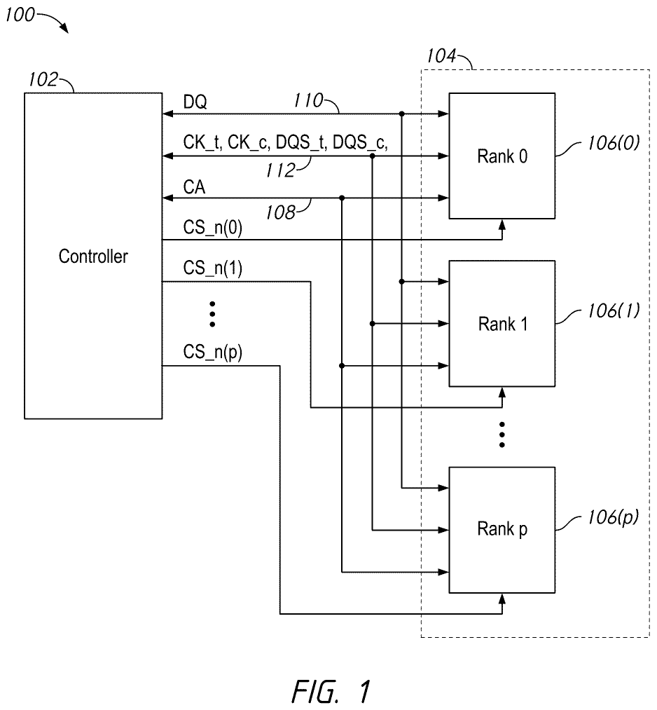

FIG. 1 illustrates a block diagram of an example system according to an embodiment of the disclosure. The system 100 includes a controller 102 and a memory system 104. In the illustrated embodiment, the memory system 104 includes memory ranks 106(0)-106(p) (e.g., “Rank 0” through “Rank p”), where p is a number greater than one (1).

Each memory rank can include one or more memory devices (e.g., DRAM devices) or memory dies. For example, the memory ranks 106(0)-106(p) may include a DRAM, a double data rate (DDR) memory, a low power double data rate (LPDDR) memory, a graphics double data rate (GDDR) memory, or other type of memory.

The memory ranks 106(0)-106(p) are each coupled to the command/address, data, and clock buses. The controller 102 and the memory system 104 are in communication over several buses. Commands and addresses (CA) are received by the memory system 104 on a command/address bus 108, and data (DQ) is provided between the controller 102 and the memory system 104 over a data bus 110. Various clocks may be provided between the controller 102 and the memory system 104 over a clock bus 112. The clock bus 112 may include signal lines for providing system clocks CK_t and CK_c received by the memory system 104 and data clocks (strobes) DQS_t and DQS_c received by the memory system 104 and/or provided to the controller 102. Each of the buses may include one or more signal lines on which signals are provided.

The CK_t and CK_c clocks provided by the controller 102 to the memory system 104 are used for timing the provision and receipt of the commands and addresses. The DQS_t and DQS_c clocks are used for timing provision of data. The CK_t and CK_c clocks are complementary, and the DQS_t and DQS_c clocks are complementary. Clocks are complementary when a rising edge of a first clock occurs at a same time as a falling edge of a second clock, and when a rising edge of the second clock occurs at a same time as a falling edge of the first clock.

The controller 102 provides commands to the memory system 104 to perform memory operations. Examples of memory commands include timing commands for controlling the timing of various operations, repair mode entry and exit commands, access commands for accessing the memory, such as read commands for performing read operations and write commands for performing write operations, activate commands, refresh command, activate command, precharge command, deselect command, no operation commands, as well as other commands. The command signals provided by the controller 102 to the memory system 104 further include external control signals (e.g., chip select signals CS_n(0), CS_n(1), CS_n(p)).

The memory ranks 106(0)-106(p) are provided the commands, addresses, data, and clocks, and the external control signals provided on respective select signal lines are used to select which of the memory ranks 106(0)-106(p) will respond to the command and perform the corresponding operation. In some embodiments, a respective control signal is provided to each memory rank 106(0)-106(p) of the memory system 104. In some embodiments, the memory dies included in a rank are provided a same control signal. The controller 102 provides an active control signal to select the corresponding memory rank 106(0)-106(p). While the respective control signal is active, the corresponding memory rank 106(0)-106(p) is selected to receive the commands and addresses provided on the command/address bus 108. In some embodiments, the external control signal is used in combination with the CA signals to indicate different memory commands and memory operations.

In operation, when an activate and a read command, and associated address are provided by the controller 102 to the memory system 104, the memory rank 106(0)-106(p) selected by the external control signals receives the activate and read commands and associated address and performs a read operation to provide the controller 102 with read data from a memory location corresponding to the associated address. The read data is provided by the selected memory rank 106(0)-106(p) to the controller 102 according to a timing relative to receipt of the read command. For example, the timing may be based on a read latency (RL) value that indicates the number of clock cycles of the CK_t and CK_c clocks (a clock cycle of the CK_t and CK_c clocks is referenced as tCK) after the read command when the read data is provided by the selected memory rank 106(0)-106(p) to the controller 102.

In preparation of the selected memory rank 106(0)-106(p) providing the read data to the controller 102, the memory device provides active data clocks DQS_t and DQS_c. A clock is active when the clock transitions between low and high clock levels periodically. Conversely, a clock is inactive when the clock maintains a constant clock level and does not transition periodically. The DQS_t and DQS_c clocks are provided by the memory rank 106(0)-106(p) performing the read operation to the controller 102 for timing the provision of read data to the controller 102. The controller 102 may use the DQS_t and DQS_c clocks for receiving the read data.

In operation, when an activate command and a write command, and associated address are provided by the controller 102 to the memory system 104, the memory rank 106(0)-106(p) selected by the external control signals receives the activate and write commands and associated address and performs a write operation to write data from the controller 102 to a memory location corresponding to the associated address. The write data is provided to the selected memory rank 106(0)-106(p) by the controller 102 according to a timing relative to receipt of the write command. For example, the timing may be based on a write latency (WL) value that indicates the number of clock cycles of the CK_t and CK_c clocks after the write command when the write data is provided to the selected memory rank 106(0)-106(p) by the controller 102. The WL value is programmed by the controller 102 in the memory ranks 106(0)-106(p). For example, the WL value may be programmed in respective mode registers of the memory ranks 106(0)-106(p).

In preparation of the selected memory rank 106(0)-106(p) receiving the write data from the controller 102, the controller 102 provides active data clocks DQS_t and DQS_c to the memory system 104. The DQS_t and DQS_c clocks may be used by the selected memory rank 106(0)-106(p) to generate internal clocks for timing the operation of circuits to receive the write data. The data is provided by the controller 102 and the selected memory rank 106(0)-106(p) receives the write data according to the DQS_t and DQS_c clocks, which is written to a memory location corresponding to the memory address.

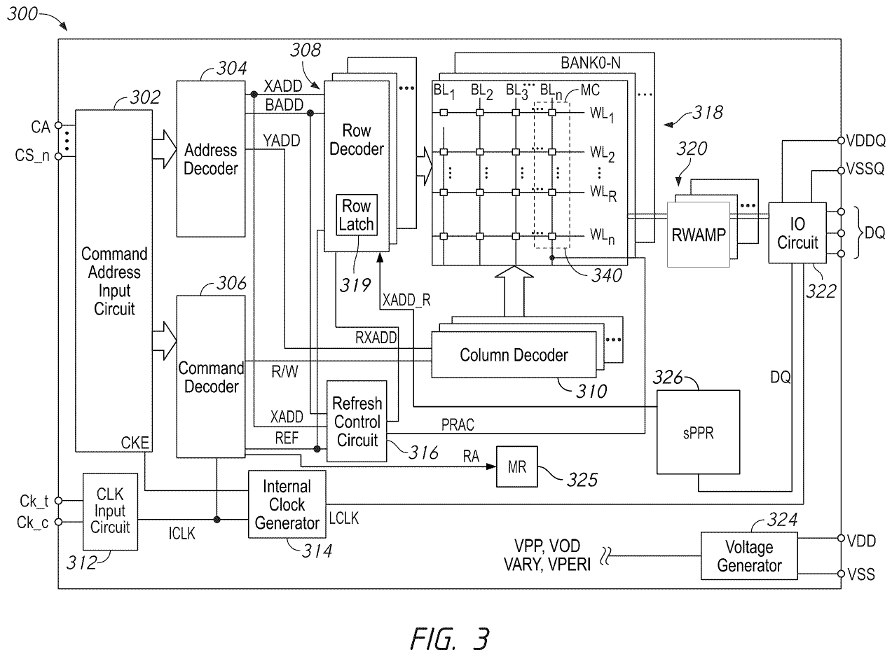

Mode register write commands and mode register read commands can be used to access the mode registers (e.g., mode register 325 in FIG. 3). In operation, when a mode register read (MRR) command and associated address are provided by the controller 102 to the memory system 104, the memory device selected by the select signals receives the mode register read command and associated address and performs a mode register read operation to provide the controller 102 with information from the mode register corresponding to the associated address. The information from the selected mode register is provided to the controller 102. When a mode register write (MRW) command and associated address are provided by the controller 102 to the memory system 104, the memory device selected by the select signals receives the mode register write command and associated address and performs a mode register write operation to write information provided by the controller 102 to a mode register corresponding to the associated address. The information is provided to the selected mode register by the controller 102. A mode register write command may provide information for setting various operating modes and/or to select features for operation of the memory dies and/or memory ranks 106(0)-106(p). In some embodiments of the disclosure, mode register settings may include enabling a repair mode and/or a repair undo mode.

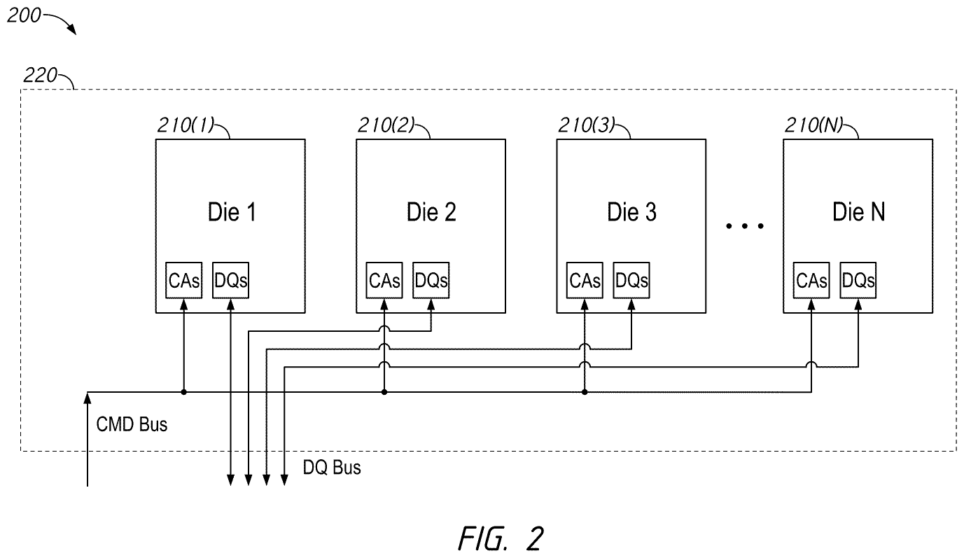

FIG. 2 illustrates a block diagram of an example memory rank according to an embodiment of the disclosure. The system 200 includes a memory rank 220 which may be an implementation of memory ranks 106(0)-106(p) of FIG. 1. In the illustrated embodiment, the memory rank 220 includes memory devices 210(1)-210(N) (e.g., “Die 0” through “Die N”), where N is a number greater than one (1). The memory devices 210(1)-210(N) may include a DRAM, a DDR memory, an LPDDR memory, a GDDR memory, or other type of memory.

The memory devices 210(1)-210(N) are each coupled to the command/address, data, and clock buses. Commands and addresses (CA) and data (DQ) may be provided between a memory system, such as 104 of FIG. 1, and a controller, such as 102 of FIG. 1, then communicated to the memory devices 210(1)-210(N) on a command bus CMD and data buses DQ internal to the memory rank 220. Each of the buses may include one or more signal lines on which signals are provided. The command bus CMD is shared by the memory devices 210(1)-210(N), and each of the memory devices 210(1)-210(N) is coupled to respective signal lines of the data bus.

In some embodiments, the memory devices 210(1)-210(N) included in a rank are provided a same control signal. The controller (e.g., 102 of FIG. 1) may provide an active control signal to select the corresponding memory rank 220 (e.g., 106(0)-106(p) of FIG. 1). While the respective control signal is active, the corresponding memory rank 220 (e.g., 106(0)-106(p) of FIG. 1) is selected to receive the commands and addresses provided on the command/address bus CMD (e.g., 108 of FIG. 1).

In operation, when an activate and a read command and associated address are provided by the controller (e.g., 102 of FIG. 1) to the memory system (e.g., 104 of FIG. 1), the memory rank 220 (e.g., 106(0)-106(p) of FIG. 1) selected by the external control signals receives the activate and read commands and associated address and communicates the command to the memory device 210(1)-210(N). The memory device 210(1)-210(N) performs a read operation to provide the controller (e.g., 102 of FIG. 1) with read data from a memory location corresponding to the associated address.

Mode registers included in each of the memory devices 210(1)-210(N) may be programmed with information for setting various operating modes and/or to select features for operation of the memory devices 210(1)-210(N). One of the settings may be for enabling a repair mode, for example, an sPPR mode, and/or enabling a repair undo mode, for example, an sPPR undo mode. A controller may program information in the mode registers by using an MRW command to cause the memory devices 210(1)-210(N) to perform a MRW operation.

The memory devices 210(1)-210(N) may have sPPR resources. In other words, the memory devices 210(1)-210(N) may have repair rows (e.g., redundant rows) set aside in their memory arrays for making repairs such as during the repair mode. If a repair row is not assigned an address of an original row, that repair row is available, and the memory device 210(1)-210(N) has sPPR resources available. A repair row may include a repair flag, such as one or more bits, that can be set to indicate whether the repair row is currently assigned to an address of an original row. For example, if the repair flag is in a first state, such as an on-state, the repair row is assigned an address of an original row and thus unavailable for use. On the other hand, if the repair flag is in a second state, such as an off-state, the repair row is not assigned an address of an original row and thus is available for use, for example, to have an address of an original row assigned to it during the repair mode. The on and/or off-state of the repair flag may be indicated by a particular bit value, such as a high or low bit value, by a combination of bit values, or the like.

FIG. 3 is a block diagram of a memory device according to at least some embodiment of the disclosure. The memory device 300 may be a semiconductor memory device, such as a DRAM device integrated on a single semiconductor chip or a memory die. In some embodiments, the memory devices 210(1)-210(N) of FIG. 2 each include the memory device 300.

The memory device 300 includes a memory array 318. The memory array 318 is shown as including a plurality of memory banks. In the embodiment of FIG. 3, the memory array 318 is shown as including a number of memory banks BANK0-BANKM. More or fewer banks may be included in the memory array 318 of other embodiments. Each memory bank includes a plurality of word lines WL, a plurality of bit lines BL, and a plurality of memory cells MC arranged at intersections of the plurality of word lines WL and the plurality of bit lines BL. The selection of the word line WL is performed by a row decoder 308 and the selection of the bit lines BL is performed by a column decoder 310. In the embodiment of FIG. 3, the row decoder 308 includes a respective row decoder for each memory bank and the column decoder 310 includes a respective column decoder for each memory bank. The bit lines BL are coupled to a respective sense amplifier. Read data from the bit line BL is amplified by the sense amplifier and transferred to read/write amplifiers 320 over complementary local data lines, transfer gate, and complementary main data lines. Conversely, write data output from the read/write amplifiers 320 is transferred to the sense amplifier over the complementary main data lines, the transfer gate, and the complementary local data lines, and written in the memory cell MC coupled to the bit line BL. A number of the memory cells may be set aside as counter memory cells 340 for each row. The counter memory cells 340 may be used to store an activation count associated with the row.

Counting activations of each row may be referred to as a PRAC scheme. In some embodiments, to implement such a scheme, each word line of a memory array has an associated activation count value stored in respective counter memory cells. The activation count value is used to determine how many times that word line has been activated. When the word line is activated the activation count value may be changed by a refresh control circuit 316, for instance incremented, by a counter circuit (not shown in FIG. 3) and compared to a mitigation threshold by a comparator. If the activation count value crosses the mitigation threshold, then the address may be added to an aggressor queue and during targeted refresh operations, the addresses in the queue are used to generate refresh addresses by the refresh control circuit 316.

The counter memory cells may be initialized with an initialization value. The initialization value may be such that it is known by the memory device or falls within a known range. There may be other situations which require initialization of the activation counters, for example, if refresh requirements are violated and the counters are placed in an unknown state. Other example situations which may require activation counter initialization may be when a repair row is designated for an original row or when a repair is undone on the original row. To prevent the random state of the activation count values from causing undesired memory operations, the memory may initialize the activation count values before memory operations begin or when the counters are in an unknown state.

The activation count of the repair row may be initialized with an operation such as an activation count update (ACU) operation or an activation count initialization (ACI) operation during which the activation count is initialized with an initialization value. The initialization value may be written to counter memory cells 340 of the repair row and may be a random number, pseudo-random number, semi-random number, deterministic number, or combinations thereof. The memory rank may then precharge or deactivate the repair row and exit the repair mode.

The memory device 300 also includes a repair circuit, for example, an sPPR circuit 326, which may include volatile memory elements that may store information about addresses in the memory array 318 and may be used to make non-permanent repairs. The address information in the sPPR circuit 326 may be communicated to row latches 319. Each row latch 319 may be associated with a particular word line of the memory array 318. In some embodiments, only repair rows WLR, of the memory array 318 may be associated with the row latches 319. Row latches 319 associated with repair row addresses may be referred to as repair address latches. The repair rows WLR may, in some embodiments, be the rows designated for use in repair operations, such as when an original word line is found to be damaged. The repair rows WLR may also be referred to as repair resources or may also be referred to as sPPR resources. During a repair operation, the original row address may be latched by a particular row latch 319. In this manner, the original row address may be associated with a repair row of the memory array 318. As a result, the repair row associated with the particular row latch 319 is accessed when the original row address is to be activated, for example, for an activate command.

A row address associated with an original row of memory may be latched into a row latch 319 during a repair operation (e.g., sPPR operation) while in a repair mode. For example, a row address associated with an original row of memory may be provided to the sPPR circuit 326. In some embodiments, the original row may be a defective or damaged row. The sPPR circuit 326 may perform an sPPR operation responsive to the memory die 300 entering in a repair mode. The memory device 300 may enter a repair mode responsive to a setting in a mode register 325. The mode register 325 may be set responsive to an external command, such as an MRW command from a controller (e.g., 102 of FIG. 1). After the sPPR operation is complete, the memory device 300 may exit the repair mode. Exiting the repair mode may occur responsive to a second setting in the mode register 325, or in some embodiments, the memory device 300 may exit the repair mode after a pre-determined amount of time passes.

The memory device 300 may employ a plurality of external terminals that include command and address (CA) terminals coupled to a command and address bus to receive commands and addresses, clock terminals to receive clocks Ck_t and Ck_c, data terminals DQ to provide data, and power supply terminals to receive power supply potentials VDD, VSS, VDDQ, and VSSQ.

The clock terminals are supplied with external clocks Ck_t and Ck_c that are provided to an input circuit 312. The external clocks may be complementary. The input circuit 312 generates an internal clock ICLK based on the Ck_t and Ck_c clocks. The ICLK clock is provided to the command decoder 310 and to an internal clock generator 314. The internal clock generator 314 provides various internal clocks LCLK based on the ICLK clock. The LCLK clocks may be used for timing operation of various internal circuits. The internal data clocks LCLK are provided to the input/output circuit 322 to time operation of circuits included in the input/output circuit 322, for example, to data receivers to time the receipt of write data.

The CA terminals may be supplied with memory addresses. The memory addresses supplied to the CA terminals are transferred, via a command/address input circuit 302, to an address decoder 304. The address decoder 304 receives the address and supplies a decoded row address XADD to the row decoder 308 and supplies a decoded column address YADD to the column decoder 310. The address decoder 304 may also supply a decoded bank address BADD, which may indicate the bank of the memory array 318 containing the decoded row address XADD and column address YADD. The CA terminals may be supplied with commands. Examples of commands include timing commands for controlling the timing of various operations, MRW commands and MRR commands for accessing mode registers, access commands for accessing the memory, such as read commands for performing read operations and write commands for performing write operations, as well as other commands and operations. The access commands may be associated with one or more row address XADD, column address YADD, and bank address BADD to indicate the memory cell(s) to be accessed. The mode register commands can be used to provide repair commands.

The commands may be provided as internal command signals to a command decoder 306 via the command/address input circuit 302. The command decoder 306 includes circuits to decode the internal command signals to generate various internal signals and commands for performing operations. For example, the command decoder 306 may provide a row command signal to select a word line and a column command signal to select a bit line.

The memory device 300 may receive an access command which is a row activate command ACT. When the row activate command ACT is received, a bank address BADD and a row address XADD are timely supplied with the row activate command ACT. The row decoder 308 may match the address XADD to an address stored in a row latch 319, and then may access the physical row associated with that row latch 319.

The memory device 300 may receive an access command which is a read command. When a read command is received, a bank address BADD and a column address YADD are timely supplied with the read command, read data is read from memory cells in the memory array 318 corresponding to the row address XADD and column address YADD. For example, the row decoder may access the word line associated with the row latch 319 which has an address which matches XADD. The read command is received by the command decoder 306, which provides internal commands so that read data from the memory array 318 is provided to the read/write amplifiers 320. The read data is output to outside from the data terminals DQ via the input/output circuit 322.

The memory device 300 may receive an access command which is a write command. When the write command is received, a bank address BADD and a column address YADD are timely supplied with the write command, write data supplied to the data terminals DQ is written to memory cells in the memory array 318 corresponding to the row address and column address. The write command is received by the command decoder 306, which provides internal commands so that the write data is received by data receivers in the input/output circuit 322. Write clocks may also be provided to the external clock terminals for timing the receipt of the write data by the data receivers of the input/output circuit 322. The write data is supplied via the input/output circuit 322 to the read/write amplifiers 320, and by the read/write amplifiers 320 to the memory array 318 to be written into the memory cell MC.

The memory device 300 may also receive commands causing it to carry out a refresh operation. The refresh signal REF may be a pulse signal which is activated when the command decoder 306 receives a signal which indicates a refresh command. In some embodiments, the refresh command may be externally issued to the memory device 300. In some embodiments, the refresh command may be periodically generated by a component of the device. In some embodiments, when an external signal indicates a self-refresh entry command, the refresh signal REF may also be activated. The refresh signal REF may be activated once immediately after command input, and thereafter may be cyclically activated at desired internal timing. Thus, refresh operations may continue automatically. A self-refresh exit command may cause the automatic activation of the refresh signal REF to stop and return to an IDLE state.

The refresh signal REF is supplied to the refresh control circuit 316. The refresh control circuit 316 supplies a refresh row address RXADD to the row decoder 308, which may refresh a word line WL indicated by the refresh row address RXADD. The refresh control circuit 316 may control a timing of the refresh operation and may generate and provide the refresh address RXADD. The refresh control circuit 316 may be controlled to change details of the refreshing address RXADD, such as how the refresh address is calculated, the timing of the refresh addresses, or may operate based on internal logic. In some embodiments, the refresh control circuit 316 may perform both refresh operations, where the word lines of the memory array 318 are refreshed in a sequence, and targeted refresh operations, where specific word lines of the memory are targeted for a refresh out of sequence from the refresh operations.

The power supply terminals are supplied with power supply potentials VDD and VSS. The power supply potentials VDD and VSS are supplied to an internal voltage generator circuit 324. The internal voltage generator circuit 324 generates various internal potentials VPP, VOD, VARY, VPERI, and the like based on the power supply potentials VDD and VSS supplied to the power supply terminals. The internal potential VPP is mainly used in the row decoder 308, the internal potentials VOD and VARY are mainly used in the sense amplifiers SAMP included in the memory array 318, and the internal potential VPERI is used in many peripheral circuit blocks.

The power supply terminals are also supplied with power supply potentials VDDQ and VSSQ. The power supply potentials VDDQ and VSSQ are supplied to the input/output circuit 322. The power supply potentials VDDQ and VSSQ supplied to the power supply terminals may be the same potentials as the power supply potentials VDD and VSS supplied to the power supply terminals in an embodiment of the disclosure. The power supply potentials VDDQ and VSSQ supplied to the power supply terminals may be different potentials from the power supply potentials VDD and VSS supplied to the power supply terminals in another embodiment of the disclosure. The power supply potentials VDDQ and VSSQ supplied to the power supply terminals are used for the input/output circuit 322 so that power supply noise generated by the input/output circuit 322 does not propagate to the other circuit blocks.

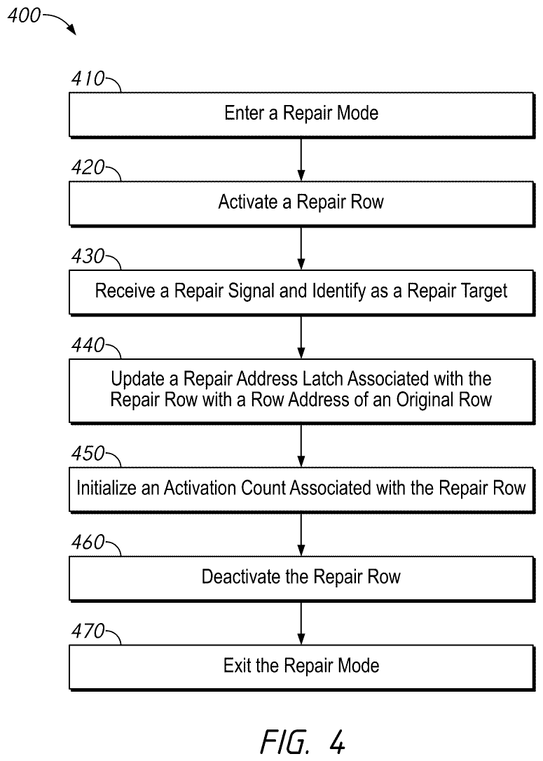

FIG. 4 is a flow chart of a repair operation according to some embodiments of the present disclosure. The method 400 may, in some embodiments, be implemented by one or more of the components described in FIGS. 1-3. The method 400 includes performing an activation count initialization of a repair row during a repair operation on a memory device.

The method 400 may begin at block 410, which describes a memory device entering a repair mode. In some embodiments, the repair mode may be an sPPR mode. The memory device (e.g., 210(1)-210(N) of FIG. 2 and/or 300 of FIG. 3) may enter the repair mode responsive to a repair command. In some embodiments, the repair command may be issued by a memory controller (e.g., 102 of FIG. 1). For example, the repair command may be an MRW command that sets a register of a mode register (e.g., 325 of FIG. 3) and enables the repair mode. The method 400 may proceed to block 420.

Block 420 describes activating a repair row. In some embodiments, the repair row may be activated by a repair circuit (e.g., sPPR circuit 326 of FIG. 3) responsive to an activate command ACT and row address issued by a controller (e.g., 102 of FIG. 1). For example, the repair circuit may transmit a repair row address associated with a repair word line WLR, or redundant word line, of a memory array (e.g., 318 of FIG. 3). The repair circuit may, for example, transmit the repair row address to a row decoder (e.g., 308 of FIG. 3) to activate the repair word line WLR. The method 400 may proceed to block 430.

Block 430 describes receiving a repair signal identifying the memory device as a repair target. In some embodiments, the repair signal may be an external signal, such as a signal issued by the controller. In some embodiments, the signal may be a data signal (e.g., DQ of FIGS. 1-3) for a write command that is provided by the controller. The repair signal may indicate a repair target, such as a memory device. The repair target may be identified by the memory device receiving a particular data signal, such as a low signal on a DQ line for a pre-determined amount of time. In some embodiments, the amount of time may be a number of clock cycles. For example, a DQ signal of “low” for eight consecutive clock cycles. More or fewer clock cycles may be an indicator in other embodiments. In some embodiments, the repair signal may be a portion of the DQ signal, such as the first or last four bits. The repair signal may identify the repair target to be a memory device with sPPR resources available. The method 400 may proceed to block 440.

Block 440 describes updating a repair address latch associated with the repair row with a row address of an original row. In some embodiments, the sPPR circuit may update the repair address latch in a row latch (e.g., 319 of FIG. 3). For example, the sPPR circuit may update the repair address latch of the row latch with a row address of an original row. In some embodiments, the original row may be a row that is defective or damaged and the repair row may be a redundant row, or word line (e.g., WLR of FIG. 3), designated to be used for repairs. In some embodiments, the original row may not be defective, but redundancy is required for other reasons. The method 400 may proceed to block 450.

Block 450 describes initializing an activation count associated with the repair row. In some embodiments, initializing the activation count may be performed responsive to an external command, such as from the controller. For example, initializing the activation count may be performed responsive to a precharge (PRE) command. In some embodiments, initializing the activation count may be performed responsive to an internal command, such as an internal command issued in the memory device. In some embodiments, initializing the activation count may be performed automatically. Initializing the activation count associated with the repair row may be performed with an ACU operation, an ACI operation, or a similar operation. The activation count associated with the repair row may be initialized to an initialization value, such as by writing the initialization value to counter memory cells of the repair row. The initialization value may be a random number, pseudo-random number, semi-random number, deterministic number, or combinations thereof. In some embodiments, the initialization value may be individualized for each word line. In other words, the initialization value may be different for every repair row. The method 400 may proceed to block 460.

Block 460 describes deactivating the repair row. The repair row may deactivate responsive to a precharge command PRE, which deactivates a word line associated with the repair row. In some embodiments, the repair row may be deactivated after completing the ACU or ACI operation. In some embodiments, the repair row may be deactivated after a pre-determined amount of time passes. In some embodiments, the repair row may precharge automatically. For example, for the earlier write command associated with the repair signal the memory device may perform a write with automatic precharge operation which automatically precharges the activated word line. The method 400 may proceed to block 470.

Block 470 describes exiting the repair mode. In some embodiments, the memory device may exit the repair mode responsive to a command, such as an external command from the controller. For example, the command may be a mode register write command to change a setting of the mode register to disable the repair mode.

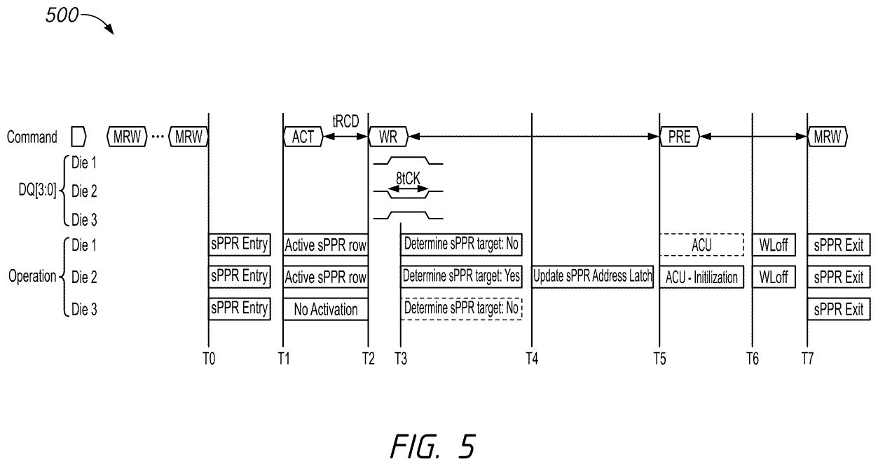

FIG. 5 is a timing chart showing signals during an example repair operation according to an embodiment of the present disclosure. In some embodiments of the disclosure the repair operation is an SPPR operation. Each of the lines of the timing chart 500 has an x-axis which represents time. The relative positions of the various signals are shown for illustrative purposes only and the positions between different signals are not to scale. Other embodiments may have different relationships between the signals.

The example repair operation of FIG. 5 will be described also with reference to the memory rank 220 of FIG. 2. One or more of the memory devices 210(1)-210(N) may also be designated as a repair target for the repair operation. In the example repair operation, it will be assumed that Die 1 210(1) and Die 2 210(2) have sPPR resources available but Die 3 210(3) does not, and additionally, Die 2 210(2) is the repair target for the repair operation.

As previously described, the repair target may be identified in a repair signal issued by the controller. In some embodiments, the repair signal may include a particular data signal DQ received by the memory die that is the repair target. For example, the memory device may receive a DQ signal that is low for a pre-determined amount of time identifying the memory device as the repair target. In some embodiments, the repair target indication may be a portion of the DQ, such as the first or last four bits. In some embodiments, the pre-determined amount of time may be a number of clock cycles, such as eight clock cycles. In some embodiments, the repair target may be required to have repair resources available to be the repair target.

The first line of the timing diagram 500 represents the issued commands. In some embodiments, one or more of the commands may be external commands, such as commands issued by a controller (e.g., 102 of FIG. 1). In some embodiments, one or more of the commands may be internal commands. The second set of lines labeled DQ(3:0) represent the four bits of the DQ signal transmitted to each die Die 1, Die 2, and Die 3. The third set of lines labeled Operation represent the operation of each die Die 1, Die 2, and Die 3.

Before an initial time T0, Die 1, Die 2, and Die 3 may receive a mode register write MRW command. The MRW command may be issued by the controller and may be a repair command. The MRW command may change, or write, a setting of the mode register in each of Die 1, Die 2, and Die 3. In some embodiments, the mode register setting may be a repair mode enable setting.

At time T0, Dies 1-3 may enter the repair mode, such as an sPPR mode. In some embodiments, Dies 1-3 may enter the repair mode responsive to a mode register setting, such as the sPPR mode enable setting.

At time T1, an activate command ACT may be issued. For example, the controller may issue the activate command. Dies 1-3 receive the activate command ACT. In some embodiments, the activate command ACT may be an internal command in the memory die. The activate command ACT may include an address for a repair row. If Die 1, Die 2, or Die 3 has available repair resources, the memory die may activate a repair row responsive to the activate command ACT. A memory die may have repair resource available if the memory array includes repair resources set aside for repairing original rows that are not in use.

At time T2, a write command WR may be issued. For example, a memory controller may issue the write command WR. Dies 1-3 receive the write command WR. In some embodiments, the write command WR may be an internal command in the memory die. Along with the write command WR, the memory controller provides repair signals in the form of DQ signals to Dies 1-3.

At time T3, one or more memory dies Dies 1-3 may identify as the repair target and the activated repair row of the repair target will be used for the sPPR operation. In some embodiments, the memory device may identify as the repair target based on the repair signals provided by the memory controller. In some embodiments, the repair signal may be data signals DQ. For example, the data signals DQ may be provided to the memory devices Die 1-3 and if a portion of the DQ signal, such as bits 0-1, is in a particular state, such as low, the memory die receiving the low DQ signal may be the repair target. In some embodiments, the state, such as low, may remain for a pre-determined amount of time, such as a number of clock cycles, to indicate the repair target.

In the example of FIG. 5, the data signal DQ received by Die 2 is in a low state for eight consecutive clock cycles, thus Die 2 is the repair target, as indicated in FIG. 5 by “Determine sPPR target: Yes.” Die 2 may identify as the repair target based on the DQ signal as discussed herein. Die 1 does not identify as the repair target even though it has sPPR resources available as indicated by “Determine sPPR target: No.” Die 3 has no sPPR resources available in the example. Identifying as the repair target is an optional step, as indicated in FIG. 5 with the dashed box around “Determine sPPR target: No.” The repair target may be determined by an external component, such as the controller.

At time T4, the repair target Die 2 may update a repair address latch associated with the repair row with a row address of an original row. In some embodiments, the repair target may write the row address of the original row to the repair address latch associated with the repair row in the row latch of the memory array of the repair target. In the example, Die 2 is the repair target and updates the repair address latch associated with the repair row with a row address of an original row.

At time T5, a precharge command PRE may be issued. In some embodiments, the precharge command PRE may be an external command, such as issued by the controller. Responsive to the precharge command PRE, the repair target Die 2 may initialize the activation count of the repair row. In some embodiments, initializing the activation count associated with the repair row may be performed with an ACU operation, an ACI operation, or a similar operation. The activation count associated with the repair row may be initialized to an initialization value. For example, the initialization value may be written to counter memory cells of the repair row. The initialization value may be a random number, pseudo-random number, semi-random number, deterministic number, or combinations thereof. In some embodiments, the initialization value may be individualized for each word line. In other words, the initialization value may be different for every repair row. In some embodiments, a memory device that is not identified as the repair target but that has sPPR resources available, may initialize an activation count associated with the repair row. This may be optional as indicated by the dashed box around “ACU” for Die 1 in the example of FIG. 5.

At time T6, activated repair rows may deactivate. The activated repair rows may deactivate responsive to a precharge command PRE, which deactivates a word line associated with the repair row. In some embodiments, the repair row may be deactivated after completing the ACU or ACI operation. In some embodiments, the repair row may be deactivated after a pre-determined amount of time passes.

At time T7, a second mode register write MRW command may be issued. For example, Die 1, Die 2, and Die 3 may receive the second mode register write MRW command. The second MRW command may be issued by a controller. The second MRW command may change, or write, a setting of the mode register. In some embodiments, the second mode register setting may be a repair mode disable setting and responsive to the mode being disabled, Die 1, Die 2, and Die 3 may exit the repair mode.

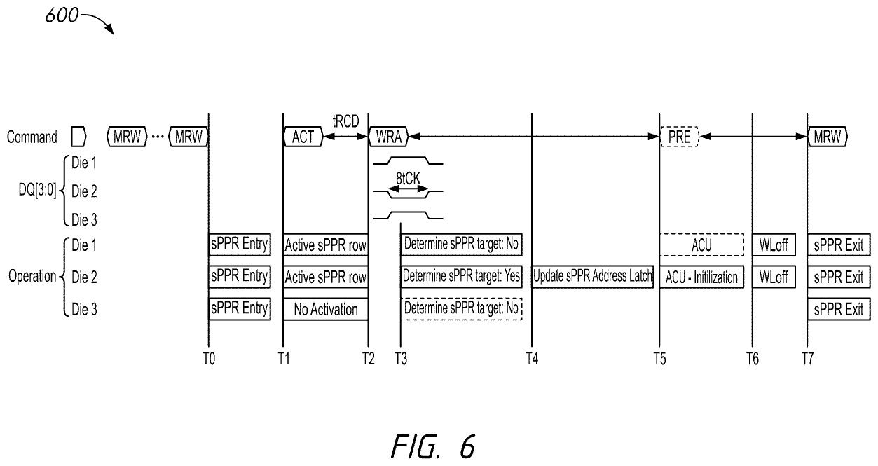

FIG. 6 is a timing chart showing signals during an example repair operation according to an embodiment of the present disclosure. In some embodiments of the disclosure the repair operation is an sPPR operation. Each of the lines of the timing chart 600 has an x-axis which represents time and may be generally similar to the timing chart 500 of FIG. 5. The relative positions of the various signals are shown for illustrative purposes only and the positions between different signals are not to scale. Other embodiments may have different relationships between the signals.

The example repair operation of FIG. 6 will be described also with reference to the memory rank 220 of FIG. 2. One or more of the memory devices 210(1)-210(N) may also be designated as a repair target for the repair operation. In the example repair operation, it will be assumed that Die 1 210(1) and Die 2 210(2) have sPPR resources available but Die 3 210(3) does not, and additionally, Die 2 210(2) is the repair target for the repair operation.

As previously described, the repair target may be identified in a repair signal issued by the controller. In some embodiments, the repair signal may include a particular data signal DQ received by the memory device that is the repair target. For example, the memory device may receive a DQ signal that is low for a pre-determined amount of time identifying the memory die as the repair target. In some embodiments, the repair target indication may be a portion of the DQ, such as the first or last four bits. In some embodiments, the pre-determined amount of time may be a number of clock cycles, such as eight clock cycles. In some embodiments, the repair target may be required to have repair resources available to be the repair target.

The first line of the timing diagram 600 represents the issued commands. In some embodiments, one or more of the commands may be external commands, such as commands issued by a controller (e.g., 102 of FIG. 1). In some embodiments, one or more of the commands may be internal commands. The second set of lines labeled DQ(3:0) represent the four bits of the DQ signal transmitted to each memory device Die 1, Die 2, and Die 3 (e.g., 210(1)-210(3) of FIG. 2) at a given time. The third set of lines labeled Operation represent the operation of each memory device Die 1, Die 2, and Die 3.

Before an initial time T0, Die 1, Die 2, and Die 3 may receive a mode register write MRW command. The MRW command may be issued by the controller and may be a repair command. The MRW command may change, or write, a setting of the mode register in each of Die 1, Die 2, and Die 3. In some embodiments, the mode register setting may be a repair mode enable setting.

At time T0, Dies 1-3 may enter the repair mode. In some embodiments, Dies 1-3 may enter the repair mode responsive to a mode register setting, such as the sPPR mode enable setting.

At time T1, an activate command ACT may be issued. The controller may issue the activate command ACT. Dies 1-3 receive the activate command ACT. In some embodiments, the activate command ACT may be an internal command in the memory device. The activate command ACT may include an address for a repair row. If Die 1, Die 2, or Die 3 has available repair, resources, the memory device may activate a repair row responsive to the activate command ACT. A memory device may have repair resources available if the memory array includes repair resources set aside for repairing original rows that are not in use.

At time T2, a write command WR may be issued. For example, a memory controller may issue the write command WR. Dies 1-3 receive the write command WR. In some embodiments, the write command may be an internal command in the memory device, such a write with automatic precharge (WRA) command. For example, Dies 1-3 may provide the WRA command. In some embodiments, the WRA command may be provided in conjunction with the write command WR and in some embodiments, the WRA command may be provided instead of the write command WR.

At time T3, one or more memory devices Dies 1-3 may identify as a repair target and the activated repair row of the repair target will be used for the sPPR operation. The repair target may be identified and/or determined based on a repair signal. In some embodiments, the repair signal may be a data signal DQ. For example, the data signal DQ may be provided to the memory devices Die 1-3 and if a portion of the data signal DQ, such as bits 0-1, is in a particular state, such as low, the memory device receiving the low data signal DQ may be the repair target. In some embodiments, the state, such as low, may remain for a pre-determined amount of time, such as a number of clock cycles, to indicate the repair target.

In the example of FIG. 6, the DQ signal received by Die 2 is in a low state for eight consecutive clock cycles, thus Die 2 is the repair target as indicated in FIG. 6 by “Determine sPPR target: Yes.” Die 2 may identify as the repair target based on the data signal DQ as discussed herein. Die 1 does not identify as the repair target even though it has sPPR resources available as indicated by “Determine sPPR target: No.” Die 3 has no sPPR resources available in the example. Identifying as the repair target is an optional step, as indicated in FIG. 6 with the dashed box around “Determine sPPR target: No.” The repair target may be determined by an external component, such as the controller.

At time T4, the repair target Die 2 may update a repair address latch associated with the repair row with a row address of an original row. In some embodiments, the repair target may write the row address of the original row to the repair address latch associated with the repair row in the row latch of the memory array of the repair target. In the example, Die 2 is the repair target and updates the repair address latch associated with the repair row with a row address of an original row.

At time T5, a precharge command PRE may be issued. In some embodiments, the precharge command PRE may be an external command, such as issued by the controller. In some embodiments, the precharge command PRE is optional. Responsive to the WRA command and not an external precharge command PRE, the repair target Die 2 may initialize the activation count of the repair row. In some embodiments, initializing the activation count associated with the repair row may be performed with an ACU operation, an ACI operation, or a similar operation. The activation count associated with the repair row may be initialized to an initialization value. For example, the initialization value may be written to counter memory cells of the repair row. The initialization value may be a random number, pseudo-random number, semi-random number, deterministic number, or combinations thereof. In some embodiments, the initialization value may be individualized for each word line. In other words, the initialization value may be different for every repair row. In some embodiments, a memory device that is not identified as the repair target but that has sPPR resources available, may initialize an activation count associated with the repair row. This may be optional as indicated by the dashed box around “ACU” for Die 1 in the example of FIG. 6. In some embodiments, the controller may issue a precharge command PRE. In the example of FIG. 6, the controller issued precharge command PRE is optional as indicated by the dashed border.

At time T6, activated repair rows may deactivate. The activated repair rows may deactivate automatically responsive to the WRA command. In some embodiments, the activated repair rows may be deactivated automatically after completing the ACU or ACI operation. In some embodiments, the activated repair rows may be deactivated after a pre-determined amount of time passes.

At time T7, a second mode register write MRW command may be issued. For example, Die 1, Die 2, and Die 3 may receive the second mode register write MRW command. The second MRW command may be issued by the controller. The second MRW command may change, or write, a setting of the mode register. In some embodiments, the second mode register setting may be a repair mode disable setting and responsive to the repair mode being disabled, Die 1, Die 2, and Die 3 may exit the repair mode.

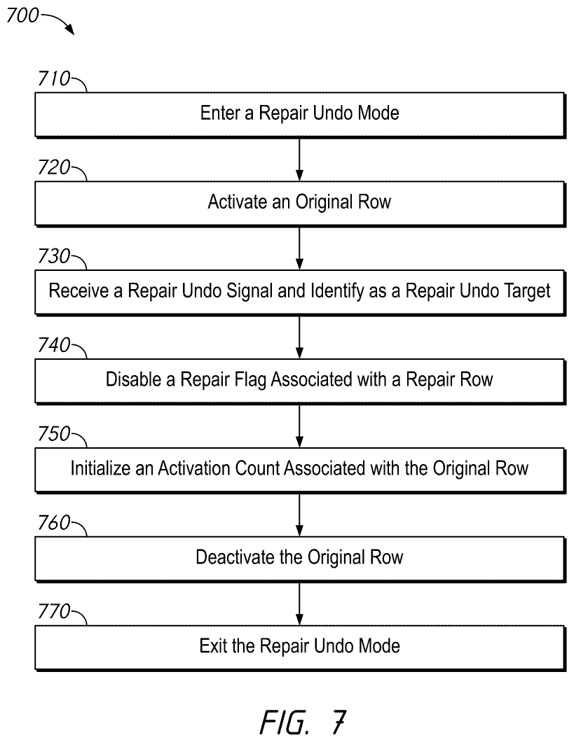

FIG. 7 is a flow chart of a repair undo operation according to some embodiments of the present disclosure. The method 700 may, in some embodiments, be implemented by one or more of the components described in FIGS. 1-3. The method 700 includes performing an activation count initialization of an original row during a repair undo operation on a memory device.

The method 700 may begin at block 710, which describes the memory device entering a repair undo mode. In some embodiments, the repair undo mode may be an sPPR undo mode. The memory device (e.g., 210(1)-210(N) of FIG. 2 and/or 300 of FIG. 3) may enter the repair undo mode responsive to a repair undo mode command. In some embodiments, the repair undo mode command may be issued by a memory controller (e.g., 102 of FIG. 1). For example, the repair undo mode command may be a mode register write command that sets a register of a mode register (e.g., 325 of FIG. 3) to enable a repair undo mode. The method 700 may proceed to block 720.

Block 720 describes activating an original row. The original row may be a row that was previously identified as defective or damaged or in need of a redundant row. In some embodiments, the original row may be activated by a repair circuit (e.g., sPPR circuit 326 of FIG. 3) responsive to an activate command ACT from a controller. For example, the repair circuit may transmit an original row address associated with an original word line WL of a memory array (e.g., 318 of FIG. 3). The repair circuit may, for example, transmit the original row address to a row decoder (e.g., 308 of FIG. 3). The method 700 may proceed to block 730.

Block 730 describes receiving a repair undo signal identifying a repair undo target. The repair undo signal may include one or more signals. In some embodiments, the repair undo signal may be an external signal, such as a signal issued by the controller. The repair undo signal may indicate a repair undo target. In some embodiments, the repair undo signal may be a data signal (e.g., DQ of FIGS. 1, 2, and/or 3) that identifies the repair undo target, such as a memory device. The repair undo target may be identified by receiving a particular data signal, such as a low signal on a DQ line for a pre-determined amount of time. In some embodiments, the amount of time may be a number of clock cycles. For example, a DQ signal of “low” for eight consecutive clock cycles. More or fewer clock cycles may be an indicator in other embodiments. In some embodiments, the repair signal may be a portion of the DQ signal, such as the first or last four bits. The repair undo target signal may identify the memory device with sPPR enabled, or available. The method 700 may proceed to block 740.

Block 740 describes disabling a repair flag associated with the repair row. The repair flag may indicate that the repair row is used for a repair on the original row. In some embodiments, the repair circuit may disable the repair flag. For example, the sPPR circuit may disable the repair flag such that the repair row is no longer associated with the original row. In some embodiments, repair flag may be one or more bits that can be set to show whether the repair row is currently assigned to an original row. For example, if the repair flag is in a first state, such as an on-state, the repair row is assigned to an original row and thus unavailable for use for a subsequent repair. On the other hand, if the repair flag is in a second state, such as an off-state, the repair row is not assigned to an original row and thus is available to have another original row assigned to it during the subsequent repair mode. The on and/or off-state of the repair flag may be indicated by a particular bit value, such as a high or low bit value, by a combination of bit values, or the like. The method 700 may proceed to block 750.

Block 750 describes initializing an activation count associated with the original row. In some embodiments, initializing the activation count may be performed responsive to an external command, such as from the controller. For example, initializing the activation count may be performed responsive to a precharge command PRE. In some embodiments, initializing the activation count may be performed responsive to an internal command, such as an internal command issued in the memory device. In some embodiments, initializing the activation count may occur automatically. Initializing the activation count associated with the repair row may be performed with an ACU operation, an ACI operation, or a similar operation. The activation count associated with the original row may be initialized to an initialization value. For example, the initialization value may be written to counter memory cells of the repair row. The initialization value may be a random number, pseudo-random number, semi-random number, deterministic number, or combinations thereof. In some embodiments, the initialization value may be individualized for each word line. In other words, the initialization value may be different for every row. The method 700 may proceed to block 760.

Block 760 describes deactivating the original row. The original row may deactivate responsive to a precharge command PRE, which deactivates a word line associated with the original row. In some embodiments, the original row may be deactivated after completing the ACU or ACI operation. In some embodiments, the original row may be deactivated after a pre-determined amount of time passes. In some embodiments, the repair row may precharge automatically. For example, for the earlier write command associated with the repair undo signal the memory die may perform a write with automatic precharge operation which automatically precharges the activated word line. The method 700 may proceed to block 770.

Block 770 describes exiting the repair undo mode. In some embodiments, the memory device may exit the repair undo mode responsive to a command, such as an external command from the controller. For example, the command may be a mode register write command to change a setting of the mode register to disable the repair undo mode.

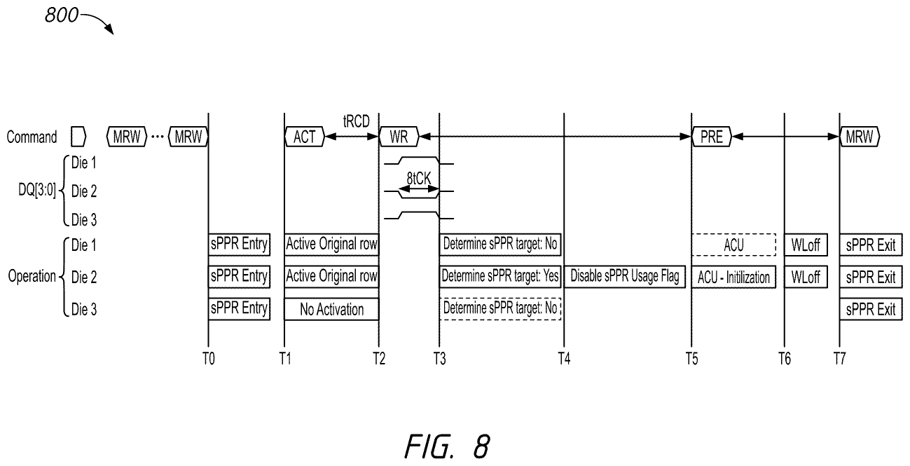

FIG. 8 is a timing chart showing signals during an example repair undo operation according to an embodiment of the present disclosure. In some embodiments of the disclosure the repair undo operation is an sPPR undo operation. Each of the lines of the timing chart 800 has an x-axis which represents time. The timing chart 800 may be generally similar to timing charts 500 of FIG. 5 and 600 of FIG. 6. The relative positions of the various signals are shown for illustrative purposes only and the positions between different signals are not to scale. Other embodiments may have different relationships between the signals.

The example repair undo operation of FIG. 8 will also be described with reference to the memory rank 220 of FIG. 2. One or more of the memory dies 210(1)-210(N) may also be designated as a repair undo target for the repair undo operation. In the example repair undo operation, it will be assumed that Die 1 210(1) and Die 2 210(2) have sPPR resources available but Die 3 210(3) does not, and additionally, Die 2 210(2) is the repair undo target for the repair undo operation.

As previously described, the repair undo target may be identified in a repair undo signal issued by the controller. In some embodiments, the repair undo signal may include a particular data signal DQ received by the memory device that is the repair undo target. For example, the memory device may receive a DQ signal that is low for a pre-determined amount of time identifying the memory device as the repair undo target. In some embodiments, the repair undo target indication may be a portion of the DQ, such as the first or last four bits. In some embodiments, the pre-determined amount of time may be a number of clock cycles, such as eight clock cycles. The repair undo target may be required to be the location of the repair row associated with the original row having the repair undone.

The first line of the timing diagram 800 represents the issued commands. In some embodiments, one or more of the commands may be external commands, such as commands issued by a controller (e.g., 102 of FIG. 1). In some embodiments, one or more of the commands may be internal commands. The second set of lines labeled DQ(3:0) represent the four bits of the data signal DQ transmitted to each memory device Die 1, Die 2, and Die 3. The third set of lines labeled Operation represent the operation of each die Die 1, Die 2, and Die 3.

Before an initial time T0, Die 1, Die 2, and Die 3 may receive a mode register write MRW command. The MRW command may be issued by the controller. The MRW command may change, or write, a setting of the mode register in each of Die 1, Die 2, and Die 3. In some embodiments, the mode register setting may be a repair undo mode enable setting.

At time T0, Dies 1-3 may enter the repair undo mode. In some embodiments, Dies 1-3 may enter the repair undo mode responsive to a mode register setting, such as the sPPR undo enable setting.

At time T1, an activate command ACT may be issued. For example, the controller may issue the activate command ACT. Dies 1-3 receive the activate command ACT. In some embodiments, the activate command ACT may be an internal command in the memory die. The activate command ACT may include an address for an original row. If Die 1, Die 2, or Die 3 has available repair resources and includes the repair row associated with the original row, the memory device may activate an original row responsive to the activate command ACT. A memory device may have repair resources available if the memory array includes repair resources set aside for repairing original rows that are not in use.

At time T2, a write command WR may be issued. For example, the write command WR may be issued by the controller. Dies 1-3 receive the write command WR. In some embodiments, the write command WR may be an internal command in the memory device.

At time T3, one or more memory devices Dies 1-3 may identify the repair undo target. The repair undo target may be the memory device on which the repair row associated with the original row is located. In some embodiments, the memory device may identify as the repair undo target based on the repair undo signal provided by the memory controller. In some embodiments, the repair undo signal may be data signals DQ. For example, the data signals DQ may be provided to the memory dies Dies 1-3 and if a portion of the DQ signal, such as bits 0-1, is in a particular state, such as low, the memory device receiving the low DQ signal may be the repair undo target. In some embodiments, the state, such as low, may remain for a pre-determined amount of time, such as a number of clock cycles, to indicate the repair undo target.

In the example of FIG. 8, the data signal DQ received by Die 2 is in a low state for eight consecutive clock cycles, thus Die 2 is the repair undo target as indicated in FIG. 8 by “Determine sPPR target: Yes.” Die 2 may identify as the repair undo target based on the data signal DQ as discussed herein. Die 1 does not identify as the repair undo target even though it has sPPR resources available as indicated by “Determine sPPR target: No.” Die 3 has no sPPR resources available in the example. Identifying as the repair undo target is an optional step, as indicated in FIG. 8 with the dashed box around “Determine sPPR target: No.” The repair undo target may be determined by an external component, such as the controller.

At time T4, the repair undo target Die 2 may disable a repair flag of the repair row associated with the original row. In some embodiments, the repair row may include a repair flag to indicate that the repair row is being used to repair an original row, such as a damaged or defective row. During a repair undo operation, the repair flag may be disabled to indicate that the repair row may be used for another original row. For example, another row found to be damaged or defective. In the example of FIG. 8, Die 2 is the repair undo target and disables the repair flag of the repair row associated with the original row.

At time T5, a precharge command PRE may be issued. In some embodiments, the precharge command may be an external command, such as issued by the controller. Responsive to the precharge command PRE, the repair undo target Die 2 may initialize the activation count of the original row. In some embodiments, initializing the activation count associated with the original row may be performed with an ACU or an ACI operation. The activation count associated with the original row may be initialized to an initialization value. For example, the initialization value may be written to counter memory cells of the original row. The initialization value may be a random number, pseudo-random number, semi-random number, deterministic number, or combinations thereof. In some embodiments, the initialization value may be individualized for each word line. In other words, the initialization value may be different for every row. In some embodiments, a memory die that is not identified as the repair undo target but that has sPPR resources available, may initialize an activation count associated with the original row on that memory die. This may be optional as indicated by the dashed box around “ACU” for Die 1 in the example of FIG. 8.

At time T6, activated original rows may deactivate. The activated original rows may deactivate responsive to a precharge command PRE, which deactivates a word line associated with the original row. In some embodiments, the activated original rows may be deactivated after completing the ACU or ACI operation. In some embodiments, the activated original rows may be deactivated after a pre-determined amount of time passes.

At time T7, a second mode register write MRW command may be issued. For example, Die 1, Die 2, and Die 3 may receive the second mode register write MRW command. The second MRW command may be issued by the controller. The second MRW command may change, or write, a setting of the mode register. In some embodiments, the second mode register setting may be a repair undo mode disable setting and responsive to the repair undo mode being disabled Die 1, Die 2, and Die 3 may exit the repair undo mode.

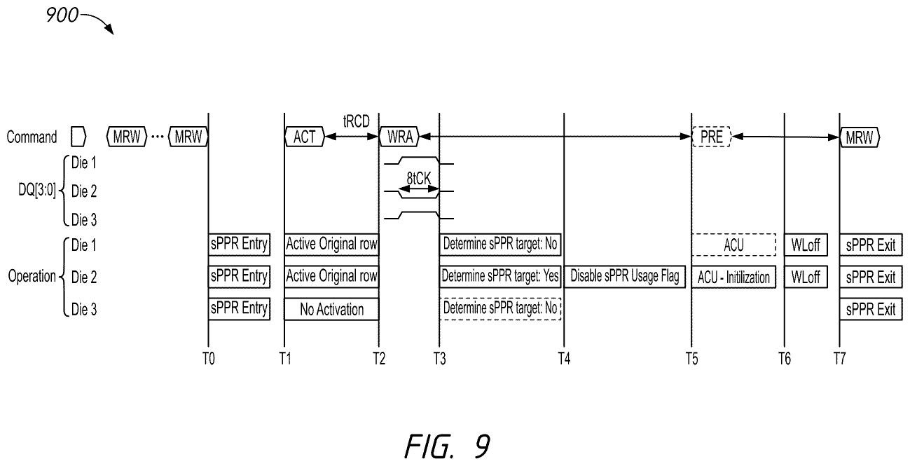

FIG. 9 is a timing chart showing signals during an example repair undo operation according to an embodiment of the present disclosure. In some embodiments of the disclosure the repair undo operation is an sPPR undo operation. Each of the lines of the timing chart 900 has an x-axis which represents time and may be generally similar to the timing chart 500 of FIGS. 5, 600 of FIG. 6, and 800 of FIG. 8. The relative positions of the various signals are shown for illustrative purposes only and the positions between different signals are not to scale. Other embodiments may have different relationships between the signals.

The example repair undo operation of FIG. 8 will also be described with reference to the memory rank 220 of FIG. 2. One or more of the memory dies 210(1)-210(N) may also be designated as a repair undo target for the repair undo operation. In the example repair undo operation, it will be assumed that Die 1 210(1) and Die 2 210(2) have sPPR resources available but Die 3 210(3) does not, and additionally, Die 2 210(2) is the repair undo target for the repair undo operation.

As previously described, the repair undo target may be identified in a repair undo signal issued by the controller. In some embodiments, the repair undo signal may include a particular data signal DQ received by the memory die that is the repair undo target. For example, the memory die may receive a DQ signal that is low for a pre-determined amount of time identifying the memory device as the repair undo target. In some embodiments, the repair undo target indication may be a portion of the DQ, such as the first or last four bits. In some embodiments, the pre-determined amount of time may be a number of clock cycles, such as eight clock cycles. The repair undo target may be required to be the location of the repair row associated with the original row having the repair undone.

The first line of the timing diagram 900 represents the issued commands. In some embodiments, one or more of the commands may be external commands, such as commands issued by a controller (e.g., 102 of FIG. 1). In some embodiments, one or more of the commands may be internal commands. The second set of lines labeled DQ(3:0) represent the four bits of the data signal DQ transmitted to each memory die Die 1, Die 2, and Die 3. The third set of lines labeled Operation represent the operation of each memory die Die 1, Die 2, and Die 3

Before an initial time T0, Die 1, Die 2, and Die 3 may receive a mode register write MRW command. The MRW command may be issued by the controller. The MRW command may change, or write, a setting of the mode register. In some embodiments, the mode register setting may be a repair undo mode enable setting.

At time T0, Dies 1-3 may enter the repair undo mode. In some embodiments, Dies 1-3 may enter the repair undo mode responsive to a mode register setting, such as the sPPR undo mode enable setting.

At time T1, an activate command ACT may be issued. The controller may issue the activate command ACT. Dies 1-3 receive the activate command ACT. In some embodiments, the activate command ACT may be an internal command in the memory device. The activate command ACT may include an address for an original row. If Die 1, Die 2, or Die 3 has available repair, resources and includes the repair row associated with the original row, the memory device may activate an original row responsive to the activate command ACT. A memory device may have repair resources available if the memory array includes repair resources set aside for repairing original rows that are not in use.

At time T2, a write command WR may be issued. In some embodiments, the WR command may be an internal command in the memory device. In some embodiments, the internal command may be a write with automatic precharge command WRA. For example, Dies 1-3 may provide the WRA command. In some embodiments, the WRA command may occur in conjunction with the write command WR.

At time T3, one or more memory devices Dies 1-3 may identify as the repair undo target. In some embodiments, the memory device may be identified as a repair undo target and the activated original row will be used for the repair undo operation. The repair undo target may be the memory device that contains the repair row associated with the original row. The repair undo target may be identified and/or determined by a repair undo signal. The repair undo signal may be data signals DQ. For example, the data signals DQ may be provided to the memory dies Die 1-3 and if a portion of the data signals DQ, such as bits 0-1, is in a particular state, such as low, the memory die receiving the low data signal DQ may be the repair undo target. In some embodiments, the state, such as low, may remain for a pre-determined amount of time, such as a number of clock cycles, to indicate the repair undo target.

In the example of FIG. 9, the data signal DQ received by Die 2 is in a low state for eight consecutive clock cycles, thus Die 2 may be determined as the repair undo target as indicated in FIG. 9 by “Determine sPPR target: Yes.” Die 2 may identify as the repair undo target based on the data signal DQ as discussed herein. Die 1 does not identify as the repair undo target even though it has sPPR resources available as indicated by “Determine sPPR target: No.” Die 3 has no sPPR resources available in the example. Identifying as the repair undo target is an optional step, as indicated in FIG. 9 with the dashed box around “Determine sPPR target: No.” The repair target may be determined by an external component, such as the controller.

At time T4, the repair undo target Die 2 may disable a repair flag of the repair row associated with the original row. In some embodiments, the repair row may include a repair flag to indicate that the repair row is being used to repair an original row, such as a damaged or defective row. During a repair undo operation, the repair flag may be disabled to indicate that the repair row may be used for another original row. For example, another row found to be damaged or defective. In the example of FIG. 9, Die 2 is the repair undo target and disables the repair flag of the repair row associated with the original row.

At time T5, a precharge command PRE may be issued. In some embodiments, the precharge command may be an external command, such as issued by the controller. In some embodiments, issuing the precharge command PRE may be optional. Responsive to the WRA command and not the external precharge command PRE, the repair undo target Die 2 may initialize the activation count of the original row. In some embodiments, initializing the activation count associated with the original row may be performed with an ACU operation, an ACI operation, or another similar operation. The activation count associated with the original row may be initialized to an initialization value. For example, the initialization value may be written to counter memory cells of the original row. The initialization value may be a random number, pseudo-random number, semi-random number, deterministic number, or combinations thereof. In some embodiments, the initialization value may be individualized for each word line. In other words, the initialization value may be different for every row. In some embodiments, a memory device that is not identified as the repair undo target but that has sPPR resources available, may initialize an activation count associated with the original row on that memory device. This may be optional as indicated by the dashed box around “ACU” for Die 1 in the example of FIG. 9. In some embodiments, a controller (e.g., 102 of FIG. 1) may issue a precharge command PRE. In the example of FIG. 9, the controller-issued precharge command PRE is optional as indicated by the dashed border.

At time T6, activated original rows may deactivate. The activated original rows may deactivate automatically responsive to the WRA command. In some embodiments, the activated original rows may be deactivated automatically after completing the ACU or ACI operation. In some embodiments, the activated original rows may be deactivated after a pre-determined amount of time passes.

At time T7, a second mode register write MRW command may be issued. For example, Die 1, Die 2, and Die 3 may receive the second mode register write MRW command. The second MRW command may be issued by the controller. The second MRW command may change, or write, a setting of the mode register. In some embodiments, the second mode register setting may be a repair undo mode disable setting and responsive to the repair undo mode being disabled, Dies 1-3 may exit the repair undo mode.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above-discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A method comprising:
at a memory device, entering a repair mode;
activating a repair row;
receiving a repair signal identifying the memory device as a repair target;
updating a repair address latch associated with the repair row with a row address of an original row;
initializing an activation count associated with the repair row;
deactivating the repair row; and
exiting the repair mode.

2. The method of claim 1, wherein the memory device enters the repair mode responsive to a repair command.

3. The method of claim 2, wherein the repair command is a mode register write command.

4. The method of claim 1, wherein deactivating the repair row occurs automatically.

5. The method of claim 4, further comprising issuing, by the memory device, a write command with automatic precharge.

6. The method of claim 1, wherein initializing the repair row comprises writing an initialization value to counter memory cells of the repair row.

7. The method of claim 6, wherein the initialization value is a random number, pseudo-random number, semi-random number, deterministic number, or combinations thereof.

8. A method comprising:
at a memory device, entering a repair undo mode;
activating an original row;
receiving a repair undo signal identifying the memory device as a repair target;
disabling a repair flag associated with the repair row;
initializing an activation count associated with the original row;
deactivating the original row; and
exiting the repair undo mode.

9. The method of claim 8, wherein the memory device enters the repair undo mode responsive to a repair undo command.

10. The method of claim 8, wherein deactivating the original row comprises:
at the memory device, receiving a precharge command; and
precharging the original row responsive to the precharge command.

11. The method of claim 8, wherein deactivating the original row occurs automatically.

12. The method of claim 11, further comprising issuing, by the memory device, a write command with automatic precharge.

13. The method of claim 8, wherein initializing the original row comprises writing an initialization value to counter memory cells of the original row.

14. The method of claim 13, wherein the initialization value is a random number, psuedo-random number, semi-random number, deterministic number, or combinations thereof.

15. An apparatus comprising:
a memory array comprising a plurality of rows including an original row and a repair row;
a repair circuit configured to:
identify as a repair target based on a repair signal;
update a repair address latch associated with the repair row with a row address of the original row; and
initialize an activation count associated with the repair row;
an input/output (IO) circuit configured to receive the repair signal.

16. The apparatus of claim 15, wherein the repair signal is low for eight clock cycles.

17. The apparatus of claim 16, wherein the repair signal is a DQ signal.

18. The apparatus of claim 15, wherein the repair circuit is further configured to:
disable a repair flag associated with the repair row responsive to a repair undo command; and
initialize a second activation count associated with the original row.

19. The apparatus of claim 15, wherein the repair circuit is further configured to initialize the activation count to an initialization value.

20. A system comprising:
a memory controller configured to transmit a repair command enabling a repair mode and indicating a repair target;
a memory system coupled to the memory controller and configured to receive the repair signal, wherein the memory system includes:
a memory rank comprising a plurality of memory devices coupled to the memory controller and each memory device of the plurality of memory devices comprising:
a memory array comprising a plurality of rows including an original row and a repair row;
a repair circuit configured to:
identify the memory device as a repair target based on the repair signal indicating the repair target;
update a repair address latch associated with the repair row with a row address of the original row; and
initialize an activation count associated with the repair row; and
an input/output (IO) circuit configured to receive the repair signal.

21. The system of claim 20, wherein the memory system further comprises a second memory rank including a second plurality of memory dies coupled to the memory controller.

22. The system of claim 20, wherein the repair command is a mode register write command and wherein the plurality of memory devices each further comprise a mode register configured to enable the repair mode based on the mode register write command.

23. The system of claim 20, wherein the memory controller is further configured to issue a repair exit command to disable the repair mode.

24. A method comprising:
issuing a repair command to a memory system comprising a memory rank to cause the memory rank to enter a repair mode;
issuing an activate command to the memory system and a repair signal identifying a memory device of the memory rank as a repair target, wherein responsive to the activate command and the repair signal the memory device:
activates a repair row;
updates a repair address latch associated with the repair row with a row address of an original row; and
initializes an activation count associated with the repair row;
issuing a precharge command to cause the memory device to deactivate the repair row; and
issuing a repair exit command to cause the memory rank to exit the repair mode.

25. The method of claim 24, wherein issuing the repair command comprising issuing a mode register write command to the memory system wherein the memory rank further comprises a mode register to cause the mode register to enable the repair mode.

26. The method of claim 24, wherein the memory device initializes the activation count responsive to the precharge command.

27. The method of claim 24, wherein the memory device initializes the activation count with an initialization value.
